(19) United States
(12) Patent Application Publication
(10) Pub. No.: US 2017/0099680 A1
(43) Pub. Date: Apr. 6, 2017

(54) TRANSMISSION POWER BASED CLEAR CHANNEL ASSESSEMENT DEFERRAL

(71) Applicant: QUALCOMM Incorporated, San Diego, CA (US)

(72) Inventors: Yan Zhou, San Diego, CA (US); Alfred Asterjadhi, San Diego, CA (US); Gwendolyn Denise Barriac, Encinitas, CA (US); Simone Merlin, San Diego, CA (US); George Cherian, San Diego, CA (US)

(21) Appl. No.: 15/266,942

(22) Filed: Sep. 15, 2016

Related U.S. Application Data
(60) Provisional application No. 62/238,003, filed on Oct. 6, 2015.

(51) Int. Cl. H04W 74/08; H04W 52/24

(52) U.S. Cl. CPC H04W 74/0816; H04W 52/245; H04W 84/12

(57) ABSTRACT

A method of controlling transmissions includes receiving, at a first wireless device, a packet from a second wireless device over a particular channel in a network. The method also includes determining a transmission power of the packet and determining a clear channel assessment threshold for the particular channel based at least in part on the transmission power. The method further includes deferring transmissions over the particular channel to the second wireless device based on the clear channel assessment threshold.

### CROSS REFERENCE TO RELATED APPLICATIONS

The present application claims the benefit of U.S. Provisional Patent Application No. 62/238,003, entitled “TRANSMISSION POWER BASED CLEAR CHANNEL ASSESSMENT DEFERRAL,” filed Oct. 6, 2015, which is expressly incorporated by reference herein in its entirety.

### FIELD

The present disclosure is generally related to deferral techniques based on a clear channel assessment.

### DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet protocol (IP) telephones, can communicate voice and packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

A first wireless device in an Institute of Electrical and Electronics Engineers (IEEE) 802.11 network may communicate with a second wireless device in the IEEE 802.11 network. For example, the first wireless device may transmit first packets to the second wireless device, and the second wireless device may transmit second packets to the first wireless device. According to IEEE 802.11 ac, the second wireless device may defer to transmissions of the first wireless device if a received signal strength indicator (RSSI) of the first packets is greater than a clear channel assessment (CCA) threshold and if a RSSI of the second packets is not greater than the CCA threshold. According to IEEE 802.11ac, the CCA threshold for a 20 Megahertz (MHz) Physical Layer Convergence Procedure (PLCP) Physical Data Unit (PPDU) is −82 decibel milli-watts (dBm).

If the first wireless device and the second wireless device have different transmission powers, the wireless device having the lower transmission power may defer to transmissions from the wireless device having the higher transmission power; however, the wireless device having the higher transmission power may not defer to transmissions from the wireless device having the lower transmission power. As a non-limiting example, the first wireless device may have a first transmission power equal to 20 dBm and the first packets may be received from the first wireless device at a first signal strength that is indicated using a first RSSI equal to −75 dBm. The second wireless device may have a second transmission power equal to 10 dBm and the second packets may be received from the second wireless device at a second signal strength that is indicated using a second RSSI equal to −85 dBm. The second wireless device may defer to transmissions from the first wireless device because the first RSSI (−75 dBm) is greater than the CCA threshold (−82 dBm). However, the first wireless device may not defer to transmissions from the second wireless device because the second RSSI (−85 dBm) is not greater than the CCA threshold (−82 dBm). As a result, the second wireless device may be allotted less air time than the first wireless device based on the deferral parameters described above. Transmissions at the second wireless device may be compressed because the second wireless device is allotted less air time.

### SUMMARY

According to one implementation of the present disclosure, a method of controlling transmissions includes receiving, at a first wireless device, a packet from a second wireless device over a particular channel in a network. The method also includes determining a transmission power of the packet and determining a clear channel assessment threshold for the particular channel based at least in part on the transmission power. The method further includes deferring transmissions over the particular channel to the second wireless device based on the clear channel assessment threshold.

According to another implementation of the present disclosure, an apparatus includes a receiver configured to receive a packet from a wireless device over a particular channel in a network. The apparatus also includes a processor couple to the receiver. The processor is configured to determine a transmission power of the packet and to determine a clear channel assessment threshold for the particular channel based at least in part on the transmission power. The apparatus also includes packet deferral circuitry configured to defer transmissions over the particular channel to the wireless device based on the clear channel assessment threshold.

According to another implementation of the present disclosure, a non-transitory computer-readable medium includes instructions for controlling transmissions. The instructions, when executed by a processor, cause the processor to perform operations that include receiving, receiving, at a first wireless device, a packet from a second wireless device over a particular channel in a network. The operations also include determining a transmission power of the packet and determining a clear channel assessment threshold for the particular channel based at least in part on the transmission power. The operations further deferring transmissions over the particular channel to the second wireless device based on the clear channel assessment threshold.

According to another implementation of the present disclosure, a first wireless device includes means for receiving a packet from a second wireless device over a particular channel in a network. The first wireless device also includes means for determining a transmission power of the packet and means for determining a clear channel assessment threshold for the particular channel based at least in part on the transmission power. The first wireless device further includes means for deferring transmissions over the particular channel to the second wireless device based on the clear channel assessment threshold.

According to another implementation of the present disclosure, a method of controlling transmissions includes determining, at a first wireless device, a nominal clear channel assessment threshold of a particular channel in a network. The method also includes determining a nominal transmission power of the particular channel. The method further includes determining a clear channel assessment threshold for the first wireless device based on the nominal clear channel assessment threshold, the nominal transmission power, and a transmission power of the first wireless device. The method also includes deferring transmissions over the particular channel to a second wireless device based on the clear channel assessment threshold.

According to another implementation of the present disclosure, an apparatus includes a processor and a memory storing instructions that are executable by the processor to perform operations. The operations include determining, at a first wireless device, a nominal clear channel assessment threshold of a particular channel in a network. The operations also include determining a nominal transmission power of the particular channel. The operations further include determining a clear channel assessment threshold for the first wireless device based on the nominal clear channel assessment threshold, the nominal transmission power, and a transmission power of the first wireless device. The operations also include deferring transmissions over the particular channel to a second wireless device based on the clear channel assessment threshold.

According to another implementation of the present disclosure, a non-transitory computer-readable medium includes instructions for controlling transmissions. The instructions, when executed by a processor, cause the processor to perform operations that include determining, at a first wireless device, a nominal clear channel assessment threshold of a particular channel in a network. The operations also include determining a nominal transmission power of the particular channel. The operations further include determining a clear channel assessment threshold for the first wireless device based on the nominal clear channel assessment threshold, the nominal transmission power, and a transmission power of the first wireless device. The operations also include deferring transmissions over the particular channel to a second wireless device based on the clear channel assessment threshold.

According to another implementation of the present disclosure, a first wireless device includes means for determining a nominal clear channel assessment threshold of a particular channel in a network. The first wireless device also includes means for determining a nominal transmission power of the particular channel. The first wireless device further includes means for determining a clear channel assessment threshold for the first wireless device based on the nominal clear channel assessment threshold, the nominal transmission power, and a transmission power of the first wireless device. The first wireless device also includes means for deferring transmissions over the particular channel to a second wireless device based on the clear channel assessment threshold.

### BRIEF DESCRIPTION OF THE DRAWINGS

FIG. 1 is a diagram that illustrates a system that is operable to support transmission power based clear channel assessment (CCA) deferrals;

FIG. 2 is a diagram that illustrates another system that is operable to support transmission power based CCA deferrals;

FIG. 3 is a flow diagram of a method of controlling transmission deferral actions;

FIG. 4 is a flow diagram of another method of controlling transmission deferral actions; and

FIG. 5 is a diagram of a wireless device that is operable to support various implementations of one or more methods, systems, apparatuses, and/or computer-readable media disclosed herein.

### DETAILED DESCRIPTION

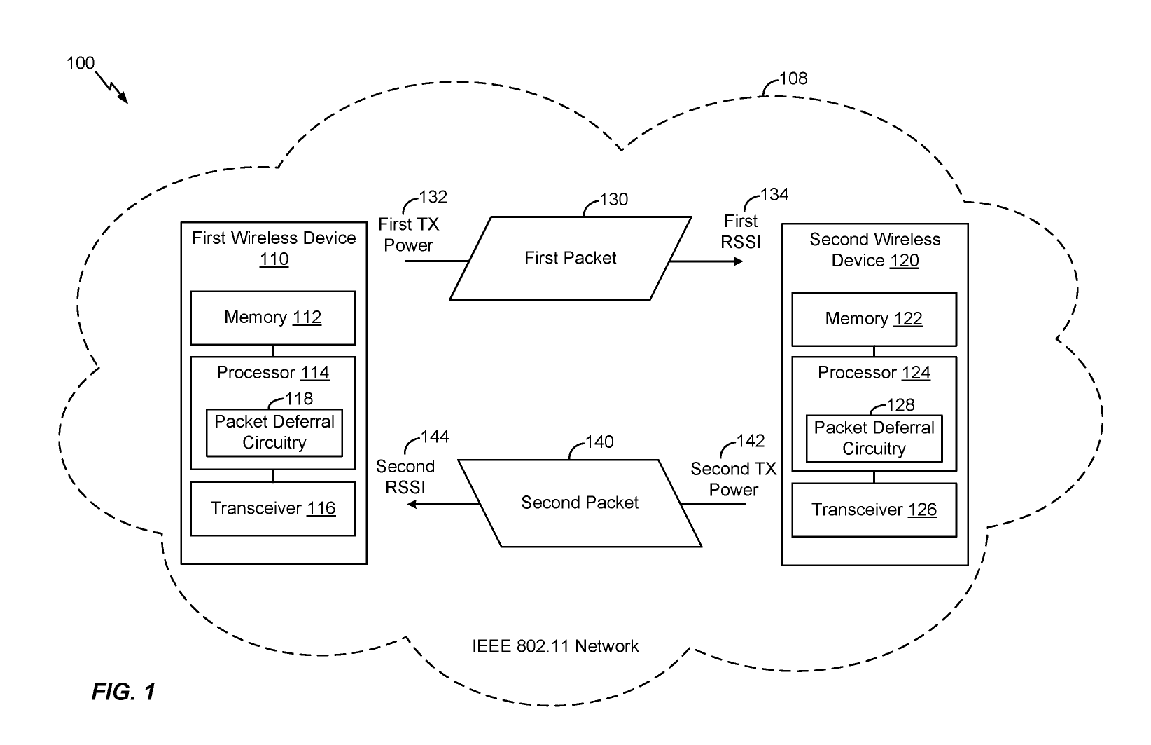

Referring to FIG. 1, a system 100 that is operable to support transmission power based clear channel assessment (CCA) deferrals is shown. The system 100 includes a first wireless device 110 and a second wireless device 120. The first wireless device 110 and the second wireless device 120 may be included in an Institute of Electrical and Electronics Engineers (IEEE) 802.11 network 108. Although FIG. 1 depicts two wireless devices 110, 120, the system 100 or the IEEE 802.11 network 108 may include more than two devices. One or more of the wireless devices 110, 120 may operate in compliance with one or more IEEE 802.11 protocols. As a non-limiting example, the wireless devices 110, 120 may operate in compliance with an IEEE 802.11ax protocol.

In some implementations, one or more of the wireless devices 110, 120 may be a node of a wireless network. For example, one or more of the wireless devices 110, 120 may be an IEEE 802.11 access point that supports and/or manages a corresponding wireless data network. To illustrate, the first wireless device 110 may support a first network, and the second wireless device 120 may access the first network via a service provided by the first wireless device 110.

The first wireless device 110 includes a memory 112, a processor 114, and a transceiver 116. The first wireless device 110 may be configured to generate a first packet 130 and to transmit the first packet 130 to the second wireless device 120. For example, the processor 114 may generate the first packet 130, and the transceiver 116 may transmit the first packet 130 to the second wireless device 120 using a particular channel or frequency band of the IEEE 802.11 network 108. The first packet 130 may be transmitted by the first wireless device 110 at a first transmission (TX) power 132, and the first packet 130 may be received by the second wireless device 120 at a first signal strength that is indicated using a first received signal strength indicator (RSSI) 134.

The second wireless device 120 includes a memory 122, a processor 124, and a transceiver 126. The second wireless device 120 may be configured to generate a second packet 140 and to transmit the second packet 140 to the first wireless device 110. For example, the processor 124 may generate the second packet 140, and the transceiver 126 may transmit the second packet 140 to the first wireless device 110 using the particular channel of the IEEE 802.11 network 108. The second packet 140 may be transmitted by the second wireless device 120 at a second transmission (TX) power 142, and the second packet 140 may be received by the first wireless device 110 at a second signal strength that is indicated using a second RSSI 144.

Because the first wireless device 110 and the second wireless device 120 use the same channel to send the first and second packets 130, 140, respectively, each wireless device 110, 120 may be configured to defer to a transmission of the other wireless device 110, 120 to reduce channel congestion. As used herein, “deferring transmissions to another device” may include deferring transmissions for a particular amount of time, deferring transmissions until the other device transmits a particular amount of packets, deferring transmissions until the other device (or a central node) indicates a channel is clear (e.g., not congested), etc. According to the techniques described below, the wireless devices 110, 120 may defer transmissions based on the transmission powers 132, 142, a nominal CCA threshold, and a nominal transmission power. For example, the processors 114, 124 may include packet deferral circuitry 118, 128, respectively, to determine transmission deferral actions based on the transmission powers 132, 142, the nominal CCA threshold, and the nominal transmission power. As used herein, a “transmission power” of a packet may include a power level used by a “transmitting device” to transmit the packet to a “receiving device”.

According to one implementation, the first wireless device 110 may send or “signal” the first transmission power 132 to the second wireless device 120 to enable the second wireless device 120 to determine transmission deferral actions. For example, the first wireless device 110 may send information indicating the first transmission power 132 to the second wireless device 120, and the packet deferral circuitry 128 may use the information to determine transmission deferral actions. In a similar manner, the second wireless device 120 may communicate the second transmission power 142 to the first wireless device 110 to enable the first wireless device 110 to determine transmission deferral actions. For example, the second wireless device 120 may send information indicating the second transmission power 142 to the first wireless device 110, and the packet deferral circuitry 118 may use the information to determine transmission deferral actions.

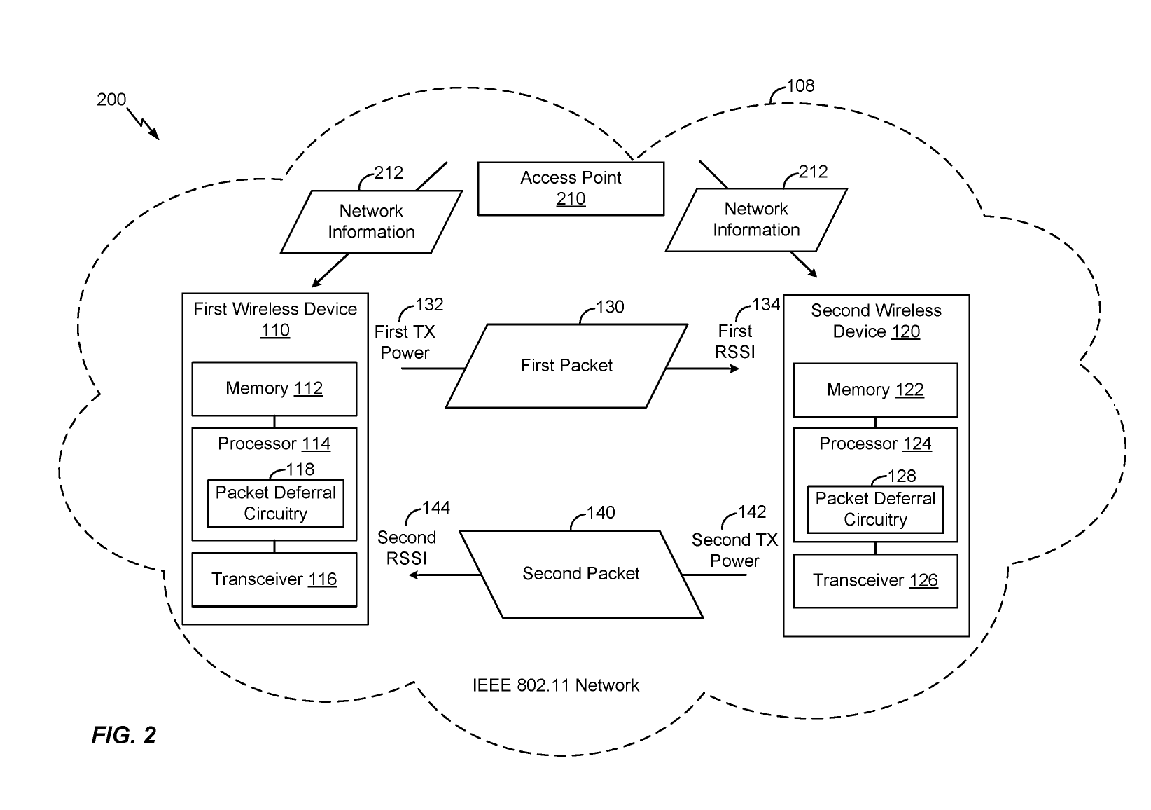

According to one implementation, the nominal CCA threshold and the nominal transmission power may be broadcast across the IEEE 802.11 network 108, as illustrated in FIG. 2. As a non-limiting example, the first wireless device 110 (or another device in the IEEE 802.11 network 108) may broadcast a frame, such as beacon frame, that includes information indicating the nominal CCA threshold and the nominal transmission power. According to another implementation, the nominal CCA threshold and the nominal transmission power may be specified in a standard, such as an IEEE 802.11 standard. The nominal CCA threshold and the nominal transmission power may be common to each node in the IEEE 802.11 network 108.

According to a first implementation of the disclosed techniques, the wireless devices 110, 120 may determine the transmission deferral actions based on a received frame's transmission power. As described below, the CCA deferral actions of the wireless devices 110, 120 may be independent of transmission power such that the wireless devices 110, 120 may defer to one another while transmitting packets at a variety of different transmission powers. To illustrate, each wireless device 110, 120 may obtain the nominal CCA threshold and the nominal transmission power by one of the above-described techniques. For a received frame having a particular transmission power (X), the receiving node may determine the CCA threshold (CCA) as a function of the nominal CCA threshold (CCAₙ), the nominal transmission power (TXₙ), and the particular transmission power (X). For example, the CCA threshold (CCA) may be expressed as:

CCA=CCAₙ−f(nTX−X) (Equation 1).

According to Equation 1, f may be a function of a transmission power difference between the nominal transmission power (TXₙ) and the particular transmission power (X). As a non-limiting illustrative example, f may be a constant such that the CCA threshold (CCA) is equal to the nominal CCA threshold (CCAₙ) minus the nominal transmission power (TXₙ) plus the particular transmission power (X). Thus, according to Equation 1, the CCA threshold (CCA) is lower than the nominal CCA threshold (CCAₙ) if the particular transmission power (X) is lower than the nominal transmission power (TXₙ). Alternatively, the CCA threshold (CCA) is higher than the nominal CCA threshold (CCAₙ) if the particular transmission power (X) is higher than the nominal transmission power (TXₙ).

An indication of the particular transmission power (X) may be provided to the receiving node using bits in a physical header of the frame. For example, the particular transmission power (X) may be signaled to the receiving node by using reserved bits in the physical header, by redefining existing bits in the physical header, or by using new fields in the physical header. To illustrate, reserved bits in a signal (SIG) field (e.g., SIG-A/SIG-B in an 802.11ax physical header) or a service field of the physical header may be used to signal the particular transmission power (X).

As a non-limiting example, the nominal CCA threshold (CCAₙ) may be equal to −82 dBm and the nominal transmission power (TXₙ) may be equal to 20 dBm. The first transmission power 132 may be equal to 15 dBm and the first RSSI 134 may be equal to −75 dBm. The second transmission power 142 may be equal to 10 dBm and the second RSSI 144 may be equal to −85 dBm. According to the techniques associated with the first implementation, the first wireless device 110 may determine transmission deferral actions based on the second transmission power 142. To illustrate, the packet deferral circuitry 118 may determine the CCA threshold (CCA₁) for the first wireless device 110 using Equation 1. For example, the CCA threshold (CCA₁) may be expressed as CCA₁=−82 dBm−1(20 dBm−10 dBm)=−92 dBm. Thus, the CCA threshold (CCA₁) is lower than the nominal CCA threshold (CCAₙ) because the second transmission power 142 is lower than the nominal transmission power (TXₙ).

Additionally, according to the techniques associated with the first implementation, the second wireless device 120 may determine transmission deferral actions based on the first transmission power 132. To illustrate, the packet deferral circuitry 128 may determine the CCA threshold (CCA₂) for the second wireless device 120 using Equation 1. For example, the CCA threshold (CCA₂) may be expressed as CCA₂=−82 dBm−1(20 dBm−15 dBm)=−87 dBm. Thus, the CCA threshold (CCA₂) is lower than the nominal CCA threshold (CCAₙ) because the first transmission power 132 is lower than the nominal transmission power (TXₙ).

Thus, according to the first implementation, the two nodes may have similar CCA deferral actions that are independent of a respective transmission power. To illustrate, the first transmission power 132 may be denoted by “A”, the second transmission power 142 may be denoted by “B”, and the path loss between the wireless devices 110, 120 may be denoted by “PL”. At the first wireless device 110, the difference (Delta_1) between the second RSSI 144 and the corresponding CCA (CCA₂) may be expressed as Delta_1=(B−PL)−(TXₙ−B)=TXₙ−CCAₙ−PL. In a similar manner, at the second wireless device 120, the difference (Delta_2) between the first RSSI 134 and the corresponding CCA (CCA₁) may be expressed as Delta_2=(A−PL)−(TXₙ−A)=TXₙ−CCAₙ−PL. Thus, the first and second wireless devices 110, 120 may have similar CCA deferral actions that depend on the nominal transmission power (TXₙ), the nominal CCA threshold (CCAₙ), and the path loss (PL). Because the CCA deferral actions of the wireless devices 110, 120 are independent of transmission power, the wireless devices 110, 120 may defer to each other while transmitting packets at a variety of different transmission powers.

According to a second implementation of the disclosed techniques, the wireless devices 110, 120 may determine the transmission deferral actions based on a node's transmission power. Each wireless device 110, 120 may obtain the nominal CCA threshold (CCAₙ) and the nominal transmission power (TXₙ) by one of the above-described techniques. For a node with a particular transmission power (Z), the node may determine a corresponding fixed CCA threshold (CCA_{f}) based on the nominal CCA threshold (CCAₙ), the nominal transmission power (TXₙ), and the particular transmission power (Z). For example, the fixed CCA threshold (CCA_{f}) may be expressed as:

CCA_{f}=CCAₙ+f(TXₙ−Z) (Equation 2).

According to Equation 2, f may be a function of a transmission power difference between the nominal transmission power (TXₙ) and the particular transmission power (Z). As a non-limiting illustrative example, f may be a constant such that the fixed CCA threshold (CCA_{f}) is equal to the nominal CCA threshold (CCAₙ) plus the nominal transmission power (TXₙ) minus the particular transmission power (Z). Thus, according to Equation 2, the wireless device 110, 120 with the higher transmission power 132, 142, respectively, may have the lower fixed CCA threshold (CCA_{f}).

As a non-limiting example, the nominal CCA threshold (CCAₙ) may be equal to −82 dBm and the nominal transmission power (TXₙ) may be equal to 20 dBm. The first transmission power 132 may be equal to 15 dBm and the first RSSI 134 may be equal to −75 dBm. The second transmission power 142 may be equal to 10 dBm and the second RSSI 144 may be equal to −85 dBm. According to the techniques associated with the second implementation, the first wireless device 110 may determine a fixed CCA threshold (CCA_{f1}) based on the first transmission power 132. To illustrate, the packet deferral circuitry 118 may determine the fixed CCA threshold (CCA_{f1}) for the first wireless device 110 using Equation 2. For example, the fixed CCA threshold (CCA_{f1}) may be expressed as CCA_{f1}=−82 dBm+1(20 dBm−15 dBm)=−77 dBm.

Additionally, according to the techniques associated with the second implementation, the second wireless device 120 may determine transmission deferral actions based on the second transmission power 142. To illustrate, the packet deferral circuitry 128 may determine a fixed CCA threshold (CCA_{f2}) for the second wireless device 120 using Equation 2. For example, the fixed CCA threshold (CCA_{f2}) may be expressed as CCA_{f2}=−82 dBm+1(20 dBm−20 dBm)=−82 dBm. Thus, the node with the higher transmission power may have the lower fixed CCA threshold (CCA_{f}).

Thus, according to the second implementation, the wireless devices 110, 120 may have similar CCA deferral actions; however, the CCA deferral actions may be based on the respective transmission power. To illustrate, the first transmission power 132 may be denoted by “A”, the second transmission power 142 may be denoted by “B”, and the path loss between the wireless devices 110, 120 may be denoted by “PL”. At the first wireless device 110, the difference (Delta_1) between the second RSSI 144 and the corresponding CCA (CCA₁) may be expressed as Delta₁=(B−PL)−(CCAₙ+(TXₙ−A))=A+B−TXₙ−CCAₙ−PL. In a similar manner, at the second wireless device 120, the difference (Delta_2) between the first RSSI 134 and the corresponding CCA (CCA₂) may be expressed as Delta₂=(A−PL)−(CCAₙ+(TXₙ−B))=A+B−TXₙ−CCAₙ−PL. Thus, the first and second wireless devices 110, 120 may have similar CCA deferral actions that depend on the nominal transmission power (TXₙ), the nominal CCA threshold (CCAₙ), the path loss (PL), and the sum of the transmission powers 132, 142. Because the first and second wireless devices 110, 120 have similar CCA deferral actions, the first and second wireless devices 110, 120 may be allotted a substantially similar amount of air time to transmit data.

The system 100 of FIG. 1 may enable the first wireless device 110 to defer to transmissions from the second wireless device 120 and may also enable the second wireless device 120 to defer to transmissions from the first wireless device 110. For example, because the CCA deferral actions of the wireless devices 110, 120 are based on transmission power, as opposed to a received signal strength indicator (RSSI), each wireless device 110, 120 may defer to transmissions from the other wireless device 110, 120 in the IEEE 802.11 network 108 so that the amount of air time allotted to each wireless device 110, 120 is substantially similar.

Referring to FIG. 2, another system 200 that is operable to support transmission power based CCA deferrals is shown. The system 200 includes the first wireless device 110, the second wireless device 120, and an access point 210. The wireless devices 110, 120 and the access point 210 may be included in the IEEE 802.11 network 108.

The access point 210 may be configured to generate network information 212 to broadcast the network information 212 to the wireless devices 110, 120. The network information 212 may include an indication of the nominal CCA threshold (CCAₙ) and an indication of the nominal transmission power (TXₙ). According to one implementation, the nominal CCA threshold (CCAₙ) and the nominal transmission power (TXₙ) may be determined by a central controller (not shown) of the IEEE 802.11 network 108. For example, the central controller may provide the nominal CCA threshold (CCAₙ) and the nominal transmission power (TXₙ) to the access point 210, and the access point 210 may generate the network information 212 in response to receiving the nominal CCA threshold (CCAₙ) and the nominal transmission power (TXₙ). The nominal CCA threshold (CCAₙ) and the nominal transmission power (TXₙ) may be defined in an IEEE 802.11 specification, such as an IEEE 802.11ax specification.

The system 200 of FIG. 2 may enable the wireless devices 110, 120 to receive the nominal CCA threshold (CCAₙ) and the nominal transmission power (TXₙ) to implement the CCA deferral actions described with respect to FIG. 1.

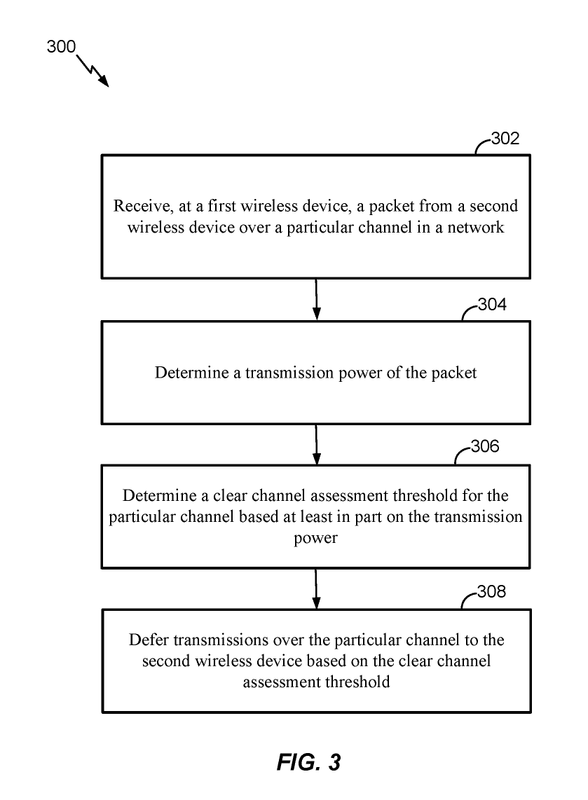

Referring to FIG. 3, a method 300 for controlling transmission deferral actions is shown. The method 300 may be performed at the first wireless device 110 of FIGS. 1-2, the second wireless device 120 of FIGS. 1-2, or both.

The method 300 includes receiving, at a first wireless device, a packet from a second wireless device over a particular channel in a network, at 302. For example, referring to FIG. 1, the first wireless device 110 may receive the second packet 140 from the second wireless device 120 over a particular channel in the IEEE 802.11 network 108.

The method 300 may also include determining a transmission power of the packet, at 304. As used herein, the transmit power of (or associated with) a packet corresponds to the transmit power at which the packet is transmitted. For example, referring to FIG. 1, the first wireless device 110 may determine the second transmission power 142 of the second packet 140. According to one implementation of the method 300, an indication of the transmission power may be provided to the first wireless device using bits in a media access control (MAC) or physical header of the packet. For example, the transmission power may be signaled to the first wireless device by using reserved bits in the MAC or physical header, by redefining existing bits in the MAC or physical header, or by using new fields in the MAC or physical header. To illustrate, reserved bits in a high throughput (HT) control field of the MAC or physical header may be used to signal the transmission power or bits in a MAC address field or frame control field may be redefined to signal the transmission power. According to one implementation, a reserved bit in the MAC or physical header may be used to indicate to the first wireless device that bits in the MAC address field or frame control field are redefined.

According to another implementation of the method 300, an indication of the transmission power may be provided to the first wireless device using bits in a physical header of the packet. For example, the transmission power may be signaled to the first wireless device by using reserved bits in the physical header, by redefining existing bits in the physical header, or by using new fields in the physical header. To illustrate, reserved bits in a signal (SIG) field (e.g., SIG-A/SIG-B in an 802.11ax physical header) or a service field of the physical header may be used to signal the transmission power. Furthermore, according to one implementation, a reserved bit in the MAC or physical header may be used to indicate to the first wireless device that bits in the physical header are redefined. In addition, the signaled transmission power can be either in absolute form or relative from, e.g. a difference from a nominal value.

The method 300 may also include determining a clear channel assessment threshold for the particular channel based at least in part on the transmission power, at 306. For example, referring to FIG. 1, the first wireless device 110 may determine the CCA threshold (CCA) as a function of the nominal CCA threshold (CCAₙ), the nominal transmission power (TXₙ), and the second transmission power 142 (“X”) according to Equation 1.

The method 300 may also include deferring transmissions over the particular channel to the second wireless device based on the clear channel assessment threshold, at 308. For example, referring to FIG. 1, the wireless devices 110, 120 may have similar CCA deferral actions that are independent of a respective transmission power. To illustrate, the first transmission power 132 may be denoted by “A”, the second transmission power 142 may be denoted by “B”, and the path loss between the wireless devices 110, 120 may be denoted by “PL”. At the first wireless device 110, the difference (Delta_1) between the second RSSI 144 and the corresponding CCA (CCA₂) may be expressed as Delta_1=(B−PL)−(TXₙ−B)=TXₙ−CCAₙ−PL. In a similar manner, at the second wireless device 120, the difference (Delta_2) between the first RSSI 134 and the corresponding CCA (CCA₁) may be expressed as Delta_2=(A−PL)−(TXₙ−A)=TXₙ−CCAₙ−PL. Therefore, Delta_1=Delta_2, and the wireless devices 110, 120 may defer transmissions over the particular channel to one another, which may result in a more “fair” allotment of air time to the wireless devices 110, 120 as compared to RSSI-based air time allotment. Thus, the first and second wireless devices 110, 120 may have similar CCA deferral actions that depend on the nominal transmission power (TXₙ), the nominal CCA threshold (CCAₙ), and the path loss (PL). Because the CCA deferral actions of the wireless devices 110, 120 is independent of transmission power, the wireless devices 110, 120 may defer to each other while transmitting packets at a variety of different transmission powers.

According to one implementation of the method 300, an indication of the transmission power may be broadcast to the first wireless device by an access point if the transmission power is a fixed transmission power. For example, referring to FIG. 2, the access point 210 may broadcast an indication of the second transmission power 142 to the first wireless device 110 in the network information 212 if the second transmission power 142 is a fixed transmission power. According to another implementation of the method 300, an indication of the transmission power may be broadcast to the first wireless device by the second wireless device if the transmission power is a fixed transmission power.

The method 300 of FIG. 3 may enable the first wireless device 110 to defer to transmissions from the second wireless device 120 and may also enable the second wireless device 120 to defer to transmissions from the first wireless device 110. For example, because the CCA deferral actions of the wireless devices 110, 120 are based on transmission power, as opposed to a RSSI, each wireless device 110, 120 may defer to transmissions from the other wireless device 110, 120 in the IEEE 802.11 network 108 so that the amount of air time allotted to each wireless device 110, 120 is substantially similar.

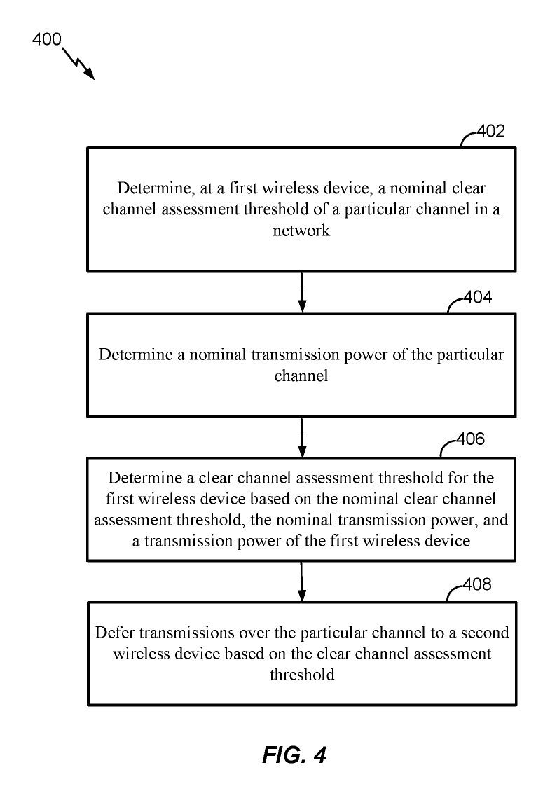

Referring to FIG. 4, another method 400 for controlling transmission deferral actions is shown. The method 400 may be performed at the first wireless device 110 of FIGS. 1-2, the second wireless device 120 of FIGS. 1-2, or both.

The method 400 includes determining, at a first wireless device, a nominal clear channel assessment threshold of a particular channel in a network, at 402. For example, referring to FIG. 2, the first wireless device 110 may receive an indication of the nominal clear channel assessment threshold (CCAₙ) from the access point 210 in the network information 212.

The method 400 may also include determining a nominal transmission power of the particular channel, at 404. For example, referring to FIG. 2, the first wireless device 110 may receive an indication of the nominal transmission power (TXₙ) from the access point 210 in the network information 212.

The method 400 may further include determining a clear channel assessment threshold for the first wireless device based on the nominal clear channel assessment threshold, the nominal transmission power, and a transmission power of the first wireless device, at 406. For example, referring to FIG. 1, the first wireless device 110 may determine the CCA threshold (CCA) as a function of the nominal CCA threshold (CCAₙ), the nominal transmission power (TXₙ), and the first transmission power 132 (“Z”) according to Equation 2.

The method may also include deferring transmissions over the particular channel to a second wireless device based on the clear channel assessment threshold, at 408. For example, referring to FIG. 1, the wireless devices 110, 120 may have similar CCA deferral actions; however, the CCA deferral actions may be based on the respective transmission power. To illustrate, the first transmission power 132 may be denoted by “A”, the second transmission power 142 may be denoted by “B”, and the path loss between the wireless devices 110, 120 may be denoted by “PL”. At the first wireless device 110, the difference (Delta_1) between the second RSSI 144 and the corresponding CCA (CCA₁) may be expressed as Delta₁=(B−PL)−(CCAₙ+(TXₙ−A))=A+B−TXₙ−CCAₙ−PL. In a similar manner, at the second wireless device 120, the difference (Delta_2) between the first RSSI 134 and the corresponding CCA (CCA₂) may be expressed as Delta₂=(A−PL)−(CCAₙ+(TXₙ−B))=A+B−TXₙ−CCAₙ−PL. Thus, the first and second wireless devices 110, 120 may have similar CCA deferral actions that depend on the nominal transmission power (TXₙ), the nominal CCA threshold (CCAₙ), the path loss (PL), and the sum of the transmission powers 132, 142.

The method 400 of FIG. 4 may enable the first wireless device 110 to defer to transmissions from the second wireless device 120 and may also enable the second wireless device 120 to defer to transmissions from the first wireless device 110. For example, because the CCA deferral actions of the wireless devices 110, 120 are based on transmission power, as opposed to a RSSI, each wireless device 110, 120 may defer to transmissions from the other wireless device 110, 120 in the IEEE 802.11 network 108 so that the amount of air time allotted to each wireless device 110, 120 is substantially similar.

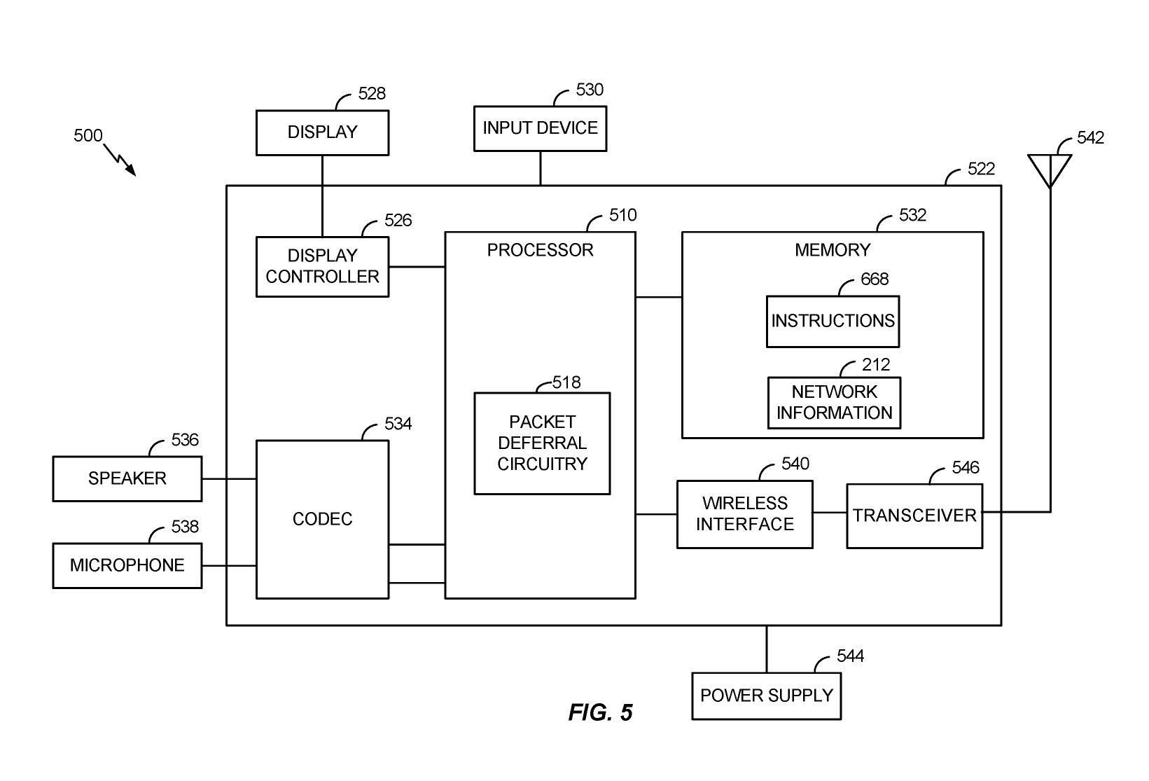

Referring to FIG. 5, a device is depicted and generally designated 500. The device 500 may correspond to the first wireless device 110 of FIGS. 1-2 or to the second wireless device 120 of FIGS. 1-2. The device 500 includes a processor 510, such as a digital signal processor or central processing unit, coupled to a memory 532.

The processor 510 may correspond to the processor 114 of FIGS. 1-2 or the processor 124 of FIGS. 1-2. The processor 510 may include packet deferral circuitry 518 that corresponds to the packet deferral circuitry 118 of FIG. 1 or the packet deferral circuitry 128 of FIG. 1. The processor 510 may be configured to execute software, such as a program of one or more instructions 568, stored in the memory 532. Additionally or alternatively, the processor 510 may be configured to execute one or more instructions stored in a memory of a wireless interface 540, such as an IEEE 802.11 interface configured to operate in accordance with an IEEE 802.11 standard. In some implementations, the processor 510 may be configured to operate in accordance with the method 300 of FIG. 3 or the method 400 of FIG. 4. For example, the memory 532 may include the network information 212. The network information 212 may include an indication of the nominal CCA threshold (CCAₙ) and an indication of the nominal transmission power (TXₙ). According to one implementation, the nominal CCA threshold (CCAₙ) and the nominal transmission power (TXₙ) may be determined by a central controller (not shown) of the IEEE 802.11 network 108. For example, the central controller may provide the nominal CCA threshold (CCAₙ) and the nominal transmission power (TXₙ) to the access point 210, and the access point 210 may generate the network information 212 in response to receiving the nominal CCA threshold (CCAₙ) and the nominal transmission power (TXₙ). According to another implementation, the nominal CCA threshold (CCAₙ) and the nominal transmission power (TXₙ) may be defined in an IEEE 802.11 standard, such as IEEE 802.11ax standard.

The wireless interface 540 may be coupled to the processor 510 and to an antenna 542.

For example, the wireless interface 540 may be coupled to the antenna 542 via a transceiver 546. The transceiver 546 may correspond to the transceiver 116 of FIGS. 1-2 or the transceiver 126 of FIGS. 1-2. A coder/decoder (CODEC) 534 can also be coupled to the processor 510. A speaker 536 and a microphone 538 can be coupled to the CODEC 534. A display controller 526 can be coupled to the processor 510 and to a display device 528. In a particular implementation, the processor 510, the display controller 526, the memory 532, the CODEC 534, and the wireless interface 540 are included in a system-in-package or system-on-chip device 522. In a particular implementation, an input device 530 and a power supply 544 are coupled to the system-on-chip device 522. Moreover, in a particular implementation, as illustrated in FIG. 5, the display device 528, the input device 530, the speaker 536, the microphone 538, the antenna 542, and the power supply 544 are external to the system-on-chip device 522. However, each of the display device 528, the input device 530, the speaker 536, the microphone 538, the antenna 542, and the power supply 544 can be coupled to one or more components of the system-on-chip device 522, such as one or more interfaces or controllers.

In conjunction with the described techniques, a first wireless device includes means for receiving a packet from a second wireless device over a particular channel in an Institute of Electrical and Electronics Engineers (IEEE) 802.11 network. For example, the means for receiving the packet may include the transceiver 116 of FIG. 1, the transceiver 546 of FIG. 5, one or more other devices, circuits, modules, or any combination thereof.

The first wireless device may also include means for determining a transmission power of the packet and means for determining a clear channel assessment threshold for the particular channel based at least in part on the transmission power. For example, the means for determining the clear channel assessment threshold may include the processor 114 of FIG. 1, the processor 510 programmed to execute the instructions 568 of FIG. 5, one or more other devices, circuits, modules, or any combination thereof.

The first wireless device may also include means for deferring transmissions over the particular channel to the second wireless device based on the clear channel assessment threshold. For example, the means for deferring transmissions over the particular channel may include the processor 114 of FIG. 1, the processor 510 programmed to execute the instructions 568 of FIG. 5, one or more other devices, circuits, modules, or any combination thereof.

Additionally, in conjunction with the described techniques, a first wireless device includes means for determining a nominal clear channel assessment threshold of a particular channel in an Institute of Electrical and Electronics Engineers (IEEE) 802.11 network. For example, the means for determining the nominal clear channel assessment threshold may include the processor 114 of FIG. 1, the processor 510 programmed to execute the instructions 568 of FIG. 5, one or more other devices, circuits, modules, or any combination thereof.

The first wireless device may also include means for determining a nominal transmission power of the particular channel. For example, the means for determining the nominal transmission power may include the processor 114 of FIG. 1, the processor 510 programmed to execute the instructions 568 of FIG. 5, one or more other devices, circuits, modules, or any combination thereof.

The first wireless device may also include means for determining a clear channel assessment threshold for the first wireless device based on the nominal clear channel assessment threshold, the nominal transmission power, and a transmission power of the first wireless device. For example, the means for determining the clear channel assessment threshold may include the processor 114 of FIG. 1, the processor 510 programmed to execute the instructions 568 of FIG. 5, one or more other devices, circuits, modules, or any combination thereof.

The first wireless device may also include means for deferring transmissions over the particular channel to a second wireless device based on the clear channel assessment threshold. For example, the means for deferring transmissions over the particular channel may include the processor 114 of FIG. 1, the processor 510 programmed to execute the instructions 568 of FIG. 5, one or more other devices, circuits, modules, or any combination thereof.

Those of skill in the art would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient (or non-transitory) storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

What is claimed is:

1. A method for controlling transmissions, the method comprising:
receiving, at a first wireless device, a packet from a second wireless device over a particular channel in a network;
determining, at the first wireless device, a transmission power of the packet;
determining, at the first wireless device, a clear channel assessment threshold for the particular channel based at least in part on the transmission power; and
deferring transmissions over the particular channel to the second wireless device based on the clear channel assessment threshold.

2. The method of claim 1, further comprising:
receiving, at the first wireless device, an indication of a nominal clear channel assessment threshold; and
receiving, at the first wireless device, an indication of a nominal transmission power;
wherein the clear channel assessment threshold is determined based on the transmission power, the nominal clear channel assessment threshold, and the nominal transmission power.

3. The method of claim 2, wherein the nominal clear channel assessment threshold and the nominal transmission power are determined by a central controller of the network.

4. The method of claim 2, wherein the nominal clear channel assessment threshold and the nominal transmission power are defined in an Institute of Electrical and Electronics Engineers (IEEE) 802.11 specification.

5. The method of claim 2, wherein the indication of the nominal clear channel assessment threshold and the indication of the nominal transmission power are broadcast to the first wireless device by an access point of the network.

6. The method of claim 1, wherein an indication of the transmission power is provided to the first wireless device using bits in a media access control header of the packet.

7. The method of claim 1, wherein an indication of the transmission power is provided to the first wireless device using bits in a physical header of the packet.

8. The method of claim 1, wherein an indication of the transmission power is broadcast to the first wireless device by an access point if the transmission power is a fixed transmission power.

9. The method of claim 1, wherein an indication of the transmission power is broadcast to the first wireless device by the second wireless device if the transmission power is a fixed transmission power.

10. An apparatus comprising:
a receiver configured to receive a packet from a wireless device over a particular channel in a network;
a processor coupled to the receiver, the processor configured to:
determine a transmission power of the packet; and
determine a clear channel assessment threshold for the particular channel based at least in part on the transmission power; and
packet deferral circuitry configured to defer transmissions over the particular channel to the wireless device based on the clear channel assessment threshold.

11. The apparatus of claim 10, wherein the receiver is further configured to:
receive an indication of a nominal clear channel assessment threshold; and
receive an indication of a nominal transmission power;
wherein the clear channel assessment threshold is determined based on the transmission power, the nominal clear channel assessment threshold, and the nominal transmission power.

12. The apparatus of claim 11, wherein the nominal clear channel assessment threshold and the nominal transmission power are determined by a central controller of the network.

13. The apparatus of claim 11, wherein the nominal clear channel assessment threshold and the nominal transmission power are defined in an Institute of Electrical and Electronics Engineers (IEEE) 802.11 specification.

14. The apparatus of claim 11, wherein the indication of the nominal clear channel assessment threshold and the indication of the nominal transmission power are broadcast by an access point of the network.

15. The apparatus of claim 10, wherein an indication of the transmission power is provided using bits in a media access control header of the packet.

16. The apparatus of claim 10, wherein an indication of the transmission power is provided using bits in a physical header of the packet.

17. The apparatus of claim 10, wherein an indication of the transmission power is broadcast by an access point if the transmission power is a fixed transmission power.

18. A non-transitory computer-readable medium comprising instructions for controlling transmissions, the instructions, when executed by a processor, cause the processor to perform operations comprising:
receiving, at a first wireless device, a packet from a second wireless device over a particular channel in a network;
determining a transmission power of the packet;
determining a clear channel assessment threshold for the particular channel based at least in part on the transmission power; and
deferring transmissions over the particular channel to the second wireless device based on the clear channel assessment threshold.

19. The non-transitory computer-readable medium of claim 18, wherein the operations further comprise:
receiving, at the first wireless device, an indication of a nominal clear channel assessment threshold; and
receiving, at the first wireless device, an indication of a nominal transmission power;
wherein the clear channel assessment threshold is determined based on the transmission power, the nominal clear channel assessment threshold, and the nominal transmission power.

20. The non-transitory computer-readable medium of claim 18, wherein the nominal clear channel assessment threshold and the nominal transmission power is determined by a central controller of the network.
